(19) United States
(12) Patent Application Publication
(10) Pub. No.: US 2014/0304140 A1
(43) Pub. Date: Oct. 9, 2014

(54) SYSTEMS AND METHODS OF FILTERING AND EXCHANGE

(71) Applicant: IP Shakti, LLC, Princeton, NJ (US)

(72) Inventor: Dipanjan Nag, Skillman, NJ (US)

(73) Assignee: IP Shakti, LLC, Princeton, NJ (US)

(21) Appl. No.: 14/248,828

(22) Filed: Apr. 9, 2014

Related U.S. Application Data
(60) Provisional application No. 61/853,640, filed on Apr. 9, 2013.

(51) Int. Cl. G06Q 40/04

(52) U.S. Cl. CPC G06Q 40/04
USPC 705/37

(57) ABSTRACT

The disclosure herein relates generally to computerized systems, and more particularly to computerized systems and methods for filtering and exchange. Systems and methods for a plurality of first investors to place their interests into an exchange database are described, wherein the interests on the exchange have been filtered using a processor and categorized to allow a plurality of second investors to purchase the interests from the first investors.

### CROSS-REFERENCE TO RELATED APPLICATIONS

This application claims the benefit of U.S. Provisional Application No. 61/853,640, filed Apr. 9, 2013, which is incorporated herein in its entirety, as if fully set forth.

### FIELD OF INVENTION

The invention herein relates to computerized systems, and more particularly to computerized systems and methods for filtering and exchange.

### BACKGROUND

A company is composed of financial interests. Interests can be embodied in forms of commercial paper, including equity, stocks, bonds, promissory notes, and convertible notes. A start-up company is a type of company. There are many types of start-up companies; however the term is usually associated with high growth rate, technology-oriented companies.

A start-up company requires funding. Investors entrust their money into a start-up company, and in return, hold interests. The failure rate of start-ups is high. If a start-up company is not mature, there is more risk to the interest. If a start-up company is more mature, the risk to the interest decreases.

An investor may hold an interest from the creation of a start-up company until the start-up company is acquired by another company. The high growth rate allows the investor to receive a high rate of return at the point of acquisition. The high rate of return incentivizes an investor to make the risky investment at the start-up's creation. A plurality of investors may hold interests in the same start-up. “Crowd funding” has become a known platform for a plurality of investors to acquire interests in start-up companies. Usually, a start-up company presents an “ask,” which is a request for an offer on an interest, and a plurality of investors may “bid,” which is an offer for an interest. If the “bid” is accepted, then the interest is transacted.

An investor who holds an interest either at creation or obtains an interest during the existence of the start-up company, may have difficulty liquidating the value of their interest from the start-up company before the point of acquisition. A start-up company usually uses all funds to achieve the high growth rate, and does not have liquid assets to allow an investor to receive the value of their interest at any time before an acquisition, transaction, or liquidity event. This creates a difficulty for investors who prioritize shorter investment times or have financial instability and need to convert their interest to available cash.

An investor may attempt to transact the interest to a second investor. A first investor may have difficultly locating a second investor to transact the interest. As crowd funding has become more wide spread, a large number of crowd investors have been created, some of whom may be low net worth investors who are now allowed to invest after the passing of 2012 Jumpstart our Business Startups Act (JOBS Act). These crowd investors may be less educated about the difficulty of liquidating the value of the interest of the company before company acquisition, transaction, or liquidity event. This creates a tension between the crowd investors and the start-up companies. There is a need for a system that allows investors to have necessary interest liquidity.

### SUMMARY

In an aspect, the invention relates to a system for the exchange of crowd-funded start-up interests. The system includes a processor and a memory. The memory stores computer readable code that, when executed by the processor, causes the processor to display a first interface, the first interface comprising an input field configured to receive a crowd-funded start-up interest from a first investor, receive the crowd-funded start-up interest from the first investor, filter the crowd-funded start-up interest to assign a category to the crowd-funded start-up interest in order to create a filtered crowd-funded start-up interest, and store the filtered crowd-funded start-up interest in an exchange database.

In an aspect, the invention relates to a computerized method for exchanging crowd-funded start-up interests. The method includes receiving a crowd-funded start-up interest from a first investor, filtering the crowd-funded start-up interest using a processor coupled to a non-transitory medium to assign a category to the crowd-funded start-up interest in order to create a filtered crowd-funded start-up interest, and storing the filtered crowd-funded start-up interest in an exchange database.

In an aspect, the invention relates to a computerized method for assigning a crowd-funded start-up interest category. The method includes receiving a crowd-funded start-up interest characteristic related to a crowd funded start-up interest, receiving a filtering criteria, applying the filtering criteria to the crowd-funded start-up interest characteristic using a processor coupled to a non-transitory medium to obtain a crowd-funded start-up interest category, calculating the crowd-funded start-up interest category, and assigning the crowd-funded start-up interest category.

In an aspect, the invention relates to a computerized method for assigning a crowd-funded start-up rating. The method includes receiving a crowd-funded start-up characteristic related to a crowd-funded start-up, receiving a rating criteria, applying the rating criteria to the crowd-funded start-up characteristic using a processor coupled to a non-transitory medium to obtain a crowd-funded start-up rating, calculating the crowd-funded start-up rating, and assigning the crowd-funded start-up rating.

### BRIEF DESCRIPTION OF THE DRAWINGS

FIG. 1 illustrates a system for the exchange of crowd-funded start-up interests.

FIG. 2 illustrates a method for exchanging crowd-funded start-up interests.

FIG. 3 illustrates a computerized method for assigning a crowd-funded start-up interest category.

FIG. 4 illustrates a computerized method for assigning a crowd-funded start-up rating.

FIG. 5 illustrates an example computing device that may be used to implement features described above with reference to FIGS. 1-4.

### DETAILED DESCRIPTION OF THE PREFERRED EMBODIMENTS

Certain terminology is used in the following description for convenience only and is not limiting. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

Disclosed herein are systems and methods for computerized exchange of crowd-funded start-up interests. The systems and methods herein allow a plurality of first investors to place their interests into an exchange database as described. These crowd-funded start-up interests have been filtered and categorized to allow a plurality of second investors to purchase the interests from the first investors.

Disclosed herein are systems for the exchange of crowd-funded start-up interests. In an embodiment, the system may include a processor and a memory. The memory may store computer readable code. When executed by the processor, the computer readable code may cause the processor to display a first interface.

The first interface may include an input field. The input field may be configured to receive a crowd-funded start-up interest from a first investor. The crowd-funded start-up interest may include any interest in a start-up obtained by participating in crowd-funding. The crowd-funded start-up interest may include an entire interest or a partial interest in the crowd-funded start-up. A first investor may include any person who invests in the crowd-funding of a start-up. A first investor may include any person who receives a crowd-funded start-up interest.

The processor may receive the input related to the crowd-funded start-up interest from the first investor. The input may be descriptive of the crowd-funded start-up interest.

The processor may filter the crowd-funded start-up interest in order to assign a category to the crowd-funded start-up interest in order to create a filtered crowd-funded start-up interest. The processor may be used to filter the input of the first investor. The processor may include an electronic part of a computer for carrying out instructions or performing operations, with examples including but not limited to central processing units, data processors, or graphics processors. Multiple processors may be used in series or in tandem. The processor may filter the input using one or more algorithms to categorize the crowd-funded start-up interest to assign the category.

The category may be based on factors related to the crowd-funded start-up interest. These factors may include but are not limited to intellectual property type, intellectual property strength, management strength exemplified by experienced entrepreneurs who have been successful in the past with startup creation and ultimate transaction of startups, presence of federal funding suggesting credible business plan and technology, whether the intellectual property is licensed from a university which would suggest peer reviewed scientific and technical merit, maturity of the crowd-funded start-up, evaluation of the technology of the crowd-funded start-up, market share of products of the crowd-funded start-up, services of the crowd-funded start-up, and the market disruptive effect of the crowd-funded start-up. The category may be a predictive metric of risk of the crowd-funded start-up interest. The category may include a high risk, a medium risk or a low risk. The category may include various levels of high risk, medium risk and low risk as each of the factors could be multifaceted creating several combinations and permutations of risk factors.

The category may include AAA, AA, A, BBB, BB and B ratings. For example, an AAA category would be of the highest quality, subject to the lowest level of credit risk. An AA category would be of high quality and subject to very low credit risk. An A category would be upper-medium grade and subject to low credit risk. A BAA category would be medium-grade and subject to moderate credit risk and as such may possess certain speculative characteristics. A BA category would be speculative and subject to substantial credit risk. A B category would be speculative and subject to high credit risk. A CAA category would be speculative of poor standing and subject to very high credit risk. A CA category would be highly speculative and are likely in, or very near, default, with some prospect of recovery of principal and interest. A C category would be the lowest rated and are typically in default, with little prospect for recovery of principal or interest.

The category may be a number expressed on scale of 1-5. For example, the traditional Morningstar Rating for stocks, such that traditional investors would be able to understand the concept quickly. The category may also be tied to the traditional risk factors of beta, which is defined as a measure of a stock's volatility in relation to the market. By definition, the market has a beta of 1.0, and individual stocks are ranked according to how much they deviate from the market. A stock that swings more than the market over time has a beta above 1.0. If a stock moves less than the market, the stock's beta is less than 1.0. High-beta stocks are supposed to be riskier but provide a potential for higher returns; low-beta stocks pose less risk but also lower returns. In this case the beta for the crowd-funded market will be significantly higher than the beta of a traditional market. Sometimes the risk is also expressed in terms of discount factor. The interest rate charged to commercial banks and other depository institutions for loans received from the Federal Reserve Bank's discount window. The discount rate also refers to the interest rate used in discounted cash flow (DCF) analysis to determine the present value of future cash flows. The discount rate in DCF analysis takes into account not just the time value of money, but also the risk or uncertainty of future cash flows; the greater the uncertainty of future cash flows, the higher the discount rate. A third meaning of the term “discount rate” is the rate used by pension plans and insurance companies for discounting their liabilities. The discount factor for a start-up can be as high as 70%-80% whereas the risk free rate of capital would be in the 3%-5% range. The creation of these categories for the second investors would be a key factor in educating the second investors before they invest in a crowd-funded start-up interest. Additionally, the risk could be expressed as a modified alpha of the market. A traditional alpha is defined as a measure of performance on a risk-adjusted basis. Alpha takes the volatility (price risk) of a mutual fund and compares its risk-adjusted performance to a benchmark index. The excess return of the fund relative to the return of the benchmark index is a fund's alpha.

The processor may store the filtered crowd-funded start-up interest in an exchange database. The exchange database may include additional information related to the crowd-funded start-up interest. This additional information may include but is not limited to an assigned first investor identification number, a crowd-funded start-up interest identification number, an interest principal value, an accrued value, an ask price, a bid price, a markup, a discount, and a yield to maturity, an offering of product, a promissory note for product or certain tangible or intangible services.

The processor may display a second interface. The second interface may include an access field configured to receive an access query from a second investor to allow the second investor to access the exchange database. The access query may include search terms related to a crowd-funded start-up interest. The access query may include search terms related to a plurality of crowd-funded start-up interests.

The processor may receive an access query from a second investor, and allow the second investor to access a segment of the exchange database based on the access query. The second investor may be a company, a partnership or an individual. The second investor may be a venture capital firm, an angel investor, a high net worth individual, a low net worth individual, an officer of the crowd-funded start-up, a representative of the crowd-funded start-up, a private equity firm, a hedge fund firm, or a speculator.

The segment of the exchange database may include but is not limited to the filtered crowd-funded start-up interest, the assigned first investor identification number, the crowd-funded start-up interest identification number, the interest principal value, the accrued value, the ask price, the bid price, the markup, the discount, and the yield to maturity. The segment of the exchange database may include multiple inputs of the exchange database based on the filtered crowd-funded start-up interest to create a fund grouping. In certain embodiments, a fund grouping may contain a number of crowd-funded start-up interests of similar categories or a number of crowd-funded start-up interests with higher and lower categories. In certain embodiments, a fund grouping may be created based on a “mutual fund” type model. In certain embodiments, an access query may be for a crowd-funded start-up interest that is separable into part interests. In certain embodiments, a fund grouping may be created based on a “bond fund” type model. Part interests may be filtered using a processor to be assigned different categories from each other. In certain embodiments, the fund grouping may also consist of multiple part interests of the crowd-funded start-up interest, or crowd-funded start-up interests and part crowd-funded start-up interests. Additional embodiments may include the first investor who desires to have additional crowd-fund start-up interest interests acting as the second investor by acquiring additional crowd-funded start-up interests that are available in the exchange database by using the systems and methods. The second investor may observe segment of the exchange database to decide to acquire the crowd-funded start-up interest associated with access query.

The processor may display a third interface. The third interface may include an information display including the segment of the exchange database. The third interface may include a selection field configured to receive a crowd-funded start-up interest selection from the second investor. The crowd-funded start-up interest selection may include the crowd-funded start-up interest that the second investor wishes to purchase from the exchange. The crowd-funded start-up interest selection may include a plurality of crowd-funded start-up interests. The crowd-funded start-up interest selection may include a partial crowd-funded start-up interest. The crowd-funded start-up interest selection may include the fund grouping. The crowd-funded start-up interest may include a plurality of fund groupings.

The processor may execute an exchange of the crowd-funded start-up interest in response to the crowd-funded start-up interest selection. The exchange may include purchase of the crowd-funded start-up interest by the second investor in exchange for money.

The first interface, the second interface and the third interface may include the same electronic device or a plurality of electronic devices.

In an embodiment, back-up database modules may also be used to include all inputs regardless of whether or not a transaction occurred. In an embodiment a transaction of a crowd-funded start-up interest occurs when the first investor uses the first interface to input details of the crowd-funded start-up interest into the exchange database, and the second investor uses the second interface to select the input and the third interface to purchase the interest. In an embodiment, the system allows for trading crowd-funded start-up interests in an electronic exchange.

In an embodiment, there can be multiple first investors inputting data corresponding to crowd-funded start-up interests using the same or different processors. In an embodiment, the system is designed to handle large numbers of first investors and second investors, and may create a market or exchange for trading, transacting, and acquiring crowd-funded start-up interests in one or more startup companies. In an embodiment, the category may be used as a market or demand based valuation assessment or metric for comparing multiple crowd-funded start-up interests.

Embodiments may include computerized methods for exchanging crowd-funded start-up interests.

The method for exchanging crowd-funded start-up interests may include receiving a crowd-funded start-up interest from a first investor. The method for exchanging crowd-funded start-up interests may further include filtering the crowd-funded start-up interest using a processor coupled to a non-transitory medium to assign a category to the crowd-funded start-up interest in order to create a filtered crowd-funded start-up interest. The method for exchanging crowd-funded start-up interests may include storing the filtered crowd-funded start-up interest in an exchange database.

The exchange database may include but is not limited to at least one or more of an assigned first investor identification number, a crowd-funded start-up interest identification number, an interest principal value, an accrued value, an ask price, a bid price, a markup, a discount, and a yield to maturity.

The method for exchanging crowd-funded start-up interests may include receiving an access query from a second investor to allow the second investor to access the exchange database. The second investor may be a company, a partnership or an individual. The second investor may be a venture capital firm, an angel investor, a high net worth individual, a low net worth individual, an officer of the crowd-funded start-up, a representative of the crowd-funded start-up, a private equity firm, a hedge fund firm, or a speculator.

The method for exchanging crowd-funded start-up interests may include receiving a crowd-funded start-up interest selection from the second investor.

The method for exchanging crowd-funded start-up interests may include executing an exchange of the crowd-funded start-up interest in response to the crowd-funded start-up interest selection.

Embodiments may include computerized methods for assigning a crowd-funded start-up interest category. The method for assigning a crowd-funded start-up interest category may include receiving a crowd-funded start-up interest characteristic related to a crowd funded start-up interest. The crowd-funded start-up interest characteristic may include at least one of intellectual property information, management information, funding information, maturity information, technology information, and market information. The crowd-funded start-up interest characteristic may include but is not limited to intellectual property type, intellectual property strength, management strength exemplified by experienced entrepreneurs who have been successful in the past with startup creation and ultimate transaction of startups, presence of federal funding suggesting credible business plan and technology, whether the intellectual property is licensed from a university which would suggest peer reviewed scientific and technical merit, maturity of the crowd-funded start-up, evaluation of the technology of the crowd-funded start-up, market share of products of the crowd-funded start-up, services of the crowd-funded start-up, and the market disruptive effect of the crowd-funded start-up.

The method for assigning a crowd-funded start-up interest category may include receiving a filtering criteria. The filtering criteria may include risk associated with each crowd-funded start-up interest characteristic. The filtering criteria may include a range of risks associated with each crowd-funded start-up interest characteristic such as high, medium and low. The range of risks may include subcategories of high, medium and low. Each crowd-funded start-up interest characteristic may be associated with a different range of risks. One crowd-funded start-up characteristic may have more weight in relation to risk than another.

The method for assigning a crowd-funded start-up interest category may include applying the filtering criteria to the crowd-funded start-up interest characteristic using a processor coupled to a non-transitory medium to obtain a crowd-funded start-up interest category.

The method for assigning a crowd-funded start-up interest category may include calculating the crowd-funded start-up interest category.

The method for assigning a crowd-funded start-up interest category may include assigning the crowd-funded start-up interest category. The crowd-funded start-up interest category may include a predictive metric of risk associated with investment in the crowd-funded start-up interest. The crowd-funded start-up interest category may include high, medium or low risk. The crowd-funded start-up interest category may include subcategories of high, medium or low risk. The crowd-funded start-up interest category may include AAA, AA, A, BBB, BB and B ratings. For example, an AAA crowd-funded start-up interest category would be of the highest quality, subject to the lowest level of credit risk. An AA crowd-funded start-up interest category would be of high quality and subject to very low credit risk. An A crowd-funded start-up interest category would be upper-medium grade and subject to low credit risk. A BAA crowd-funded start-up interest category would be medium-grade and subject to moderate credit risk and as such may possess certain speculative characteristics. A BA crowd-funded start-up interest category would be speculative and subject to substantial credit risk. A B crowd-funded start-up interest category would be speculative and subject to high credit risk. A CAA crowd-funded start-up interest category would be speculative of poor standing and subject to very high credit risk. A CA crowd-funded start-up interest category would be highly speculative and are likely in, or very near, default, with some prospect of recovery of principal and interest. A C crowd-funded start-up interest category would be the lowest rated and are typically in default, with little prospect for recovery of principal or interest.

The crowd-funded start-up interest category may be a number expressed on scale of 1-5. For example, the traditional Morningstar Rating for stocks, such that traditional investors would be able to understand the concept quickly. The crowd-funded start-up interest category may also be tied to the traditional risk factors of beta, which is defined as a measure of a stock's volatility in relation to the market. By definition, the market has a beta of 1.0, and individual stocks are ranked according to how much they deviate from the market. A stock that swings more than the market over time has a beta above 1.0. If a stock moves less than the market, the stock's beta is less than 1.0. High-beta stocks are supposed to be riskier but provide a potential for higher returns; low-beta stocks pose less risk but also lower returns. In this case the beta for the crowd-funded market will be significantly higher than the beta of a traditional market. Sometimes the risk is also expressed in terms of discount factor. The interest rate charged to commercial banks and other depository institutions for loans received from the Federal Reserve Bank's discount window. The discount rate also refers to the interest rate used in discounted cash flow (DCF) analysis to determine the present value of future cash flows. The discount rate in DCF analysis takes into account not just the time value of money, but also the risk or uncertainty of future cash flows; the greater the uncertainty of future cash flows, the higher the discount rate. A third meaning of the term “discount rate” is the rate used by pension plans and insurance companies for discounting their liabilities. The discount factor for a start-up can be as high as 70%-80% whereas the risk free rate of capital would be in the 3%-5% range. The creation of these crowd-funded start-up interest categories for the second investors would be a key factor in educating the second investors before they invest in a crowd-funded start-up interest. Additionally, the risk could be expressed as a modified alpha of the market. A traditional alpha is defined as a measure of performance on a risk-adjusted basis. Alpha takes the volatility (price risk) of a mutual fund and compares its risk-adjusted performance to a benchmark index. The excess return of the fund relative to the return of the benchmark index is a fund's alpha.

Embodiments may include computerized methods for assigning a crowd-funded start-up rating.

The method for assigning a crowd-funded start-up rating may include receiving a crowd-funded start-up characteristic related to a crowd-funded start-up. The crowd-funded start-up characteristic may include but is not limited to at least one of intellectual property information, management information, funding information, maturity information, technology information, and market information of the crowd-funded start-up.

The method for assigning a crowd-funded start-up rating may include receiving a rating criteria. The rating criteria may include a level of risk associated with each crowd-funded start-up characteristic. The level of risk associated with each crowd-funded start-up characteristic may be high, medium or low. The level of risk associated with each crowd-funded start-up characteristic may include subcategories of high, medium and low. One crowd-funded start-up characteristic may have more weight in relation to risk than another.

The method for assigning a crowd-funded start-up rating may include applying the rating criteria to the crowd-funded start-up characteristic using a processor coupled to a non-transitory medium to obtain a crowd-funded start-up rating.

The method for assigning a crowd-funded start-up rating may include calculating the crowd-funded start-up rating.

The method for assigning a crowd-funded start-up rating may include assigning the crowd-funded start-up rating. The crowd-funded start-up rating may include a predictive rating of the risk associated with the crowd-funded start-up. The crowd-funded start-up rating may be associated with a high, medium or low level of risk. The crowd-funded start-up ranking may be associated with different levels of risk with the high, medium and low risk ratings. The crowd-funded start-up rating may include AAA, AA, A, BBB, BB and B ratings. For example, an AAA crowd-funded start-up rating would be of the highest quality, subject to the lowest level of credit risk. An AA crowd-funded start-up rating would be of high quality and subject to very low credit risk. An A crowd-funded start-up rating would be upper-medium grade and subject to low credit risk. A BAA crowd-funded start-up rating would be medium-grade and subject to moderate credit risk and as such may possess certain speculative characteristics. A BA crowd-funded start-up rating would be speculative and subject to substantial credit risk. A B crowd-funded start-up rating would be speculative and subject to high credit risk. A CAA crowd-funded start-up rating would be speculative of poor standing and subject to very high credit risk. A CA crowd-funded start-up rating would be highly speculative and are likely in, or very near, default, with some prospect of recovery of principal and interest. A C crowd-funded start-up rating would be the lowest rated and are typically in default, with little prospect for recovery of principal or interest.

The crowd-funded start-up interest rating may be a number expressed on scale of 1-5. For example, the traditional Morningstar Rating for stocks, such that traditional investors would be able to understand the concept quickly. The crowd-funded start-up interest rating may also be tied to the traditional risk factors of beta, which is defined as a measure of a stock's volatility in relation to the market. By definition, the market has a beta of 1.0, and individual stocks are ranked according to how much they deviate from the market. A stock that swings more than the market over time has a beta above 1.0. If a stock moves less than the market, the stock's beta is less than 1.0. High-beta stocks are supposed to be riskier but provide a potential for higher returns; low-beta stocks pose less risk but also lower returns. In this case the beta for the crowd-funded market will be significantly higher than the beta of a traditional market. Sometimes the risk is also expressed in terms of discount factor. The interest rate charged to commercial banks and other depository institutions for loans received from the Federal Reserve Bank's discount window. The discount rate also refers to the interest rate used in discounted cash flow (DCF) analysis to determine the present value of future cash flows. The discount rate in DCF analysis takes into account not just the time value of money, but also the risk or uncertainty of future cash flows; the greater the uncertainty of future cash flows, the higher the discount rate. A third meaning of the term “discount rate” is the rate used by pension plans and insurance companies for discounting their liabilities. The discount factor for a start-up can be as high as 70%-80% whereas the risk free rate of capital would be in the 3%-5% range. The creation of these crowd-funded start-up interest ratings for the first investors would be a key factor in educating the first investors before they invest in a crowd-funded start-up. Additionally, the risk could be expressed as a modified alpha of the market. A traditional alpha is defined as a measure of performance on a risk-adjusted basis. Alpha takes the volatility (price risk) of a mutual fund and compares its risk-adjusted performance to a benchmark index. The excess return of the fund relative to the return of the benchmark index is a fund's alpha.

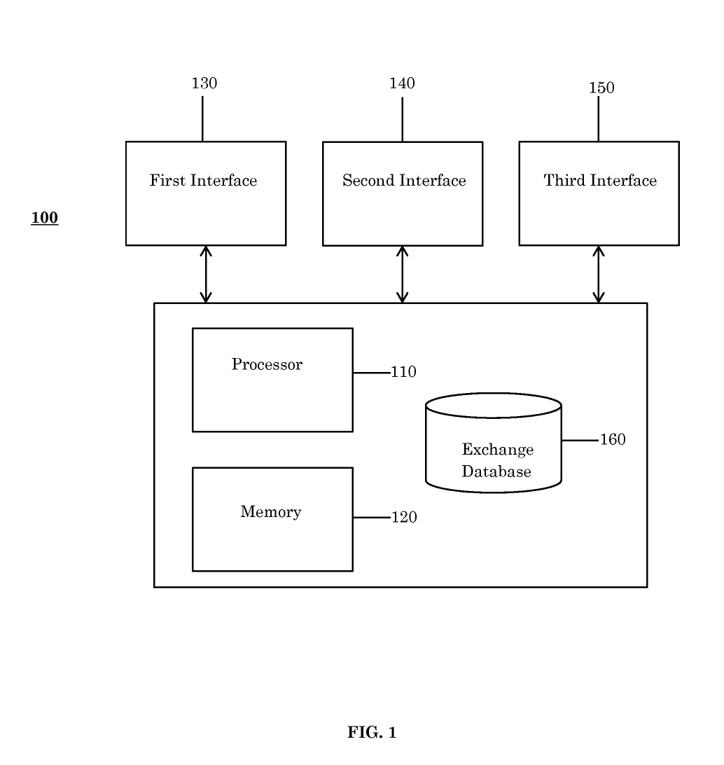

Referring to FIG. 1, a system 100 for the exchange of crowd-funded start-up interests is illustrated with a processor 110, a memory 120, a first interface 130, a second interface 140, a third interface 150, and an exchange database 160.

The memory 120 may store computer readable code. When executed by the processor 110, the computer readable code may cause the processor 110 to display a first interface 130. The first interface 130 may include an input field. The input field may be configured to receive a crowd-funded start-up interest from a first investor. The processor 110 may receive the input related to the crowd-funded start-up interest from the first investor. The input may be descriptive of the crowd-funded start-up interest.

The processor 110 may filter the crowd-funded start-up interest in order to assign a category to the crowd-funded start-up interest in order to create a filtered crowd-funded start-up interest. The processor 110 may store the filtered crowd-funded start-up interest in an exchange database 160. The processor 110 may display a second interface 140. The second interface 140 may include an access field configured to receive an access query from a second investor to allow the second investor to access the exchange database 160.

The processor 110 may receive an access query from a second investor, and allow the second investor to access a segment of the exchange database 160 based on the access query.

The processor 110 may display a third interface 150. The third interface 150 may include an information display including the segment of the exchange database. The third interface 150 may include a selection field configured to receive a crowd-funded start-up interest selection from the second investor.

The processor 110 may execute an exchange of the crowd-funded start-up interest in response to the crowd-funded start-up interest selection. The exchange may include purchase of the crowd-funded start-up interest by the second investor in exchange for money.

In an embodiment, single or multiple first investors can use the first interface 130 to input values, which can correlate to crowd-funded start-up interests. The first interface 130 may include electronic devices for input or output of information in visual or tactile form. In some embodiments, the first investor may use a plurality of first interfaces 130 corresponding to similar or different hardware.

In an embodiment, single or multiple second investors may use the second interface 140 to input the access query related to the crowd-funded start-up interest. The second interface 140 may include electronic devices for input or output of information in visual or tactile form.

In an embodiment, single or multiple second investors may use the third interface 150 to input the crowd-funded start-up interest selection. The third interface may include electronic devices for input or output of the information in visual or tactile form.

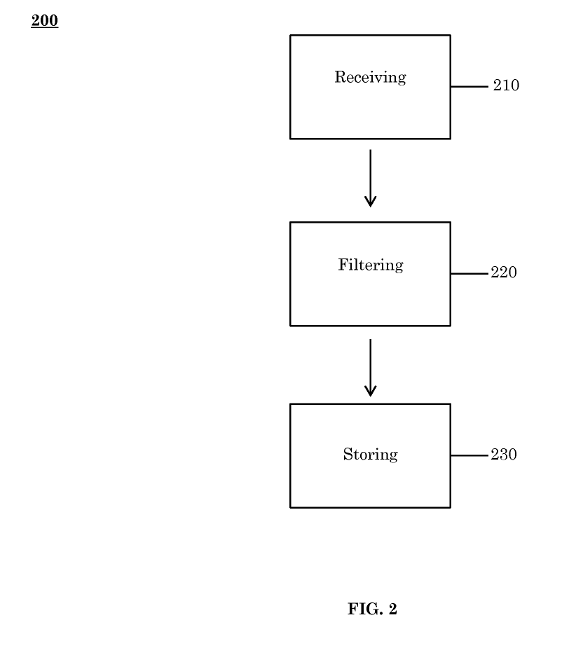

Referring to FIG. 2, a method 200 for exchanging crowd-funded start-up interests is illustrated. Method 200 may include step 210 receiving a crowd-funded start-up interest from a first investor, step 220 filtering the crowd-funded start-up interest using a processor coupled to a non-transitory medium to assign a category to the crowd-funded start-up interest in order to create a filtered crowd-funded start-up interest, and step 230 storing the filtered crowd-funded start-up interest in an exchange database.

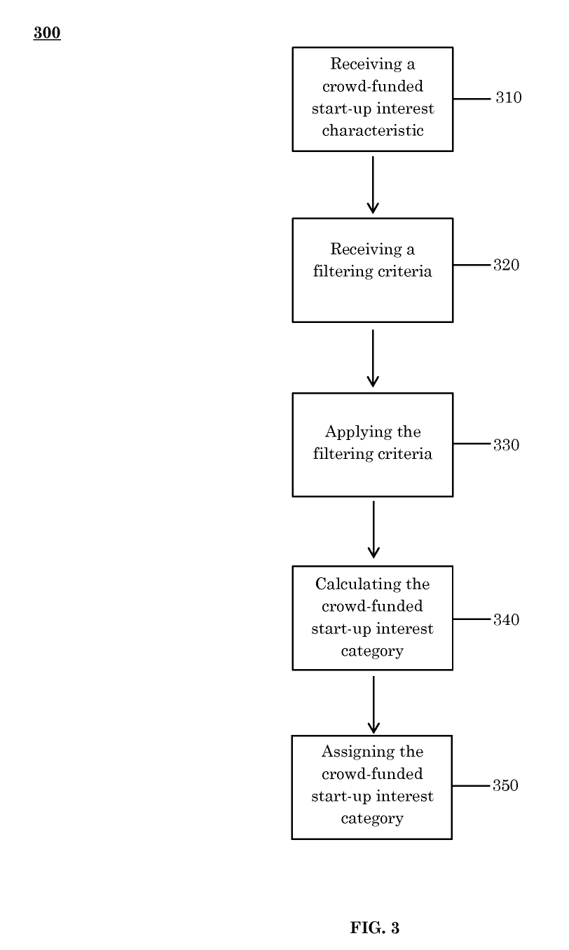

Referring to FIG. 3, a computerized method 300 for assigning a crowd-funded start-up interest category is illustrated. Method 300 may include step 310 receiving a crowd-funded start-up interest characteristic related to a crowd funded start-up interest, step 320 receiving a filtering criteria, step 330 applying the filtering criteria to the crowd-funded start-up interest characteristic using a processor coupled to a non-transitory medium to obtain a crowd-funded start-up interest category, step 340 calculating the crowd-funded start-up interest category, and step 350 assigning the crowd-funded start-up interest category.

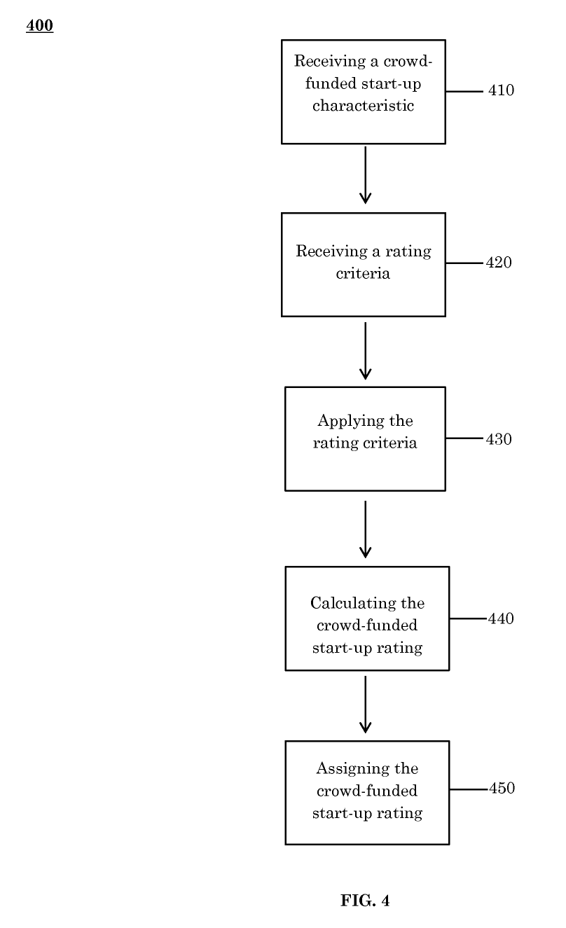

Referring to FIG. 4, a computerized method 400 for assigning a crowd-funded start-up rating is illustrated. Method 400 may include step 410 receiving a crowd-funded start-up characteristic related to a crowd-funded start-up, step 420 receiving a rating criteria, step 430 applying the rating criteria to the crowd-funded start-up characteristic using a processor coupled to a non-transitory medium to obtain a crowd-funded start-up rating, step 440 calculating the crowd-funded start-up rating, and step 450 assigning the crowd-funded start-up rating.

In certain embodiments, a first investor may have acquired one or more interests in one or more startup companies through a crowd funding platform or platform company and desires to transact the interest to a second or a plurality of second investors before the startup company is acquired or becomes otherwise publically traded. In these embodiments, the first investor may input the details of their one or more interests into the database, which is searchable using a user interface by one or more second investors. One or more first investors with interests obtained through a crowd funding platform could thereby create interest liquidity by using the systems and methods described herein to create a uniform exchange platform for the transaction of interests.

System and Method Embodiments Hardware

This section provides an overview of example hardware and operating environment in conjunction with which embodiments of the inventive subject matter can be implemented.

A software program may be launched from a computer-readable medium in a computer-based system to execute functions defined by the user interface modules, processor modules, or database modules. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized.

Embodiments may comprise a computer, a memory system, a magnetic or optical disk, some other storage device, or any type of electronic device or system. The article may include one or more processor(s) coupled to a machine-accessible medium such as a memory (e.g., a memory including electrical, optical, or electromagnetic elements). The medium may contain associated information (e.g., computer program instructions, data, or both) which, when accessed, results in a machine (e.g., the processor(s)) performing the activities previously described herein.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which show by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the embodiments of the invention require more features than are expressly recited. Rather, inventive subject matter lies in less than all features of a single disclosed embodiment.

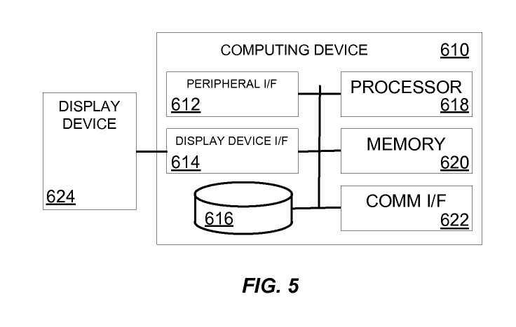

FIG. 5 shows an example computing device 610 that may be used to implement features describe above with reference to FIGS. 1-4. The computing device 610 includes a processor 618, memory device 620, communication interface 622, peripheral device interface 612, display device interface 614, and data storage device 616. FIG. 5 also shows a display device 624, which may be coupled to or included within the computing device 610.

The memory device 620 may be or include a device such as a Dynamic Random Access Memory (D-RAM), Static RAM (S-RAM), or other RAM or a flash memory. The data storage device 616 may be or include a hard disk, a magneto-optical medium, an optical medium such as a CD-ROM, a digital versatile disk (DVDs), or Blu-Ray disc (BD), or other type of device for electronic data storage.

The communication interface 622 may be, for example, a communications port, a wired transceiver, a wireless transceiver, and/or a network card. The communication interface 622 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 612 is configured to communicate with one or more peripheral devices. The peripheral device interface 612 operates using a technology such as Universal Serial Bus (USB), PS/2, Bluetooth, infrared, serial port, parallel port, and/or other appropriate technology. The peripheral device interface 612 may, for example, receive input data from an input device such as a keyboard, a mouse, a trackball, a touch screen, a touch pad, a stylus pad, and/or other device. Alternatively or additionally, the peripheral device interface 612 may communicate output data to a printer that is attached to the computing device 610 via the peripheral device interface 612.

The display device interface 614 may be an interface configured to communicate data to display device 624. The display device 624 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 614 may operate using technology such as Video Graphics Array (VGA), Super VGA (S-VGA), Digital Visual Interface (DVI), High-Definition Multimedia Interface (HDMI), or other appropriate technology. The display device interface 614 may communicate display data from the processor 618 to the display device 624 for display by the display device 624. As shown in FIG. 5, the display device 624 may be external to the computing device 610, and coupled to the computing device 610 via the display device interface 614. Alternatively, the display device 624 may be included in the computing device 610.

An instance of the computing device 610 of FIG. 5 may be configured to perform any feature or any combination of features described above. Alternatively or additionally, the memory device 620 and/or the data storage device 616 may store instructions which, when executed by the processor 618, cause the processor 618 to perform any feature or any combination of features described above. Alternatively or additionally, each or any of the features described above may be performed by the processor 618 in conjunction with the memory device 620, communication interface 622, peripheral device interface 612, display device interface 614, and/or storage device 616.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above with reference to an example architecture, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-5 may be used alone without the other features and elements or in various combinations with or without other features and elements. Sub-elements and/or sub-steps of the methods described above with reference to FIGS. 1-5 may be performed in any arbitrary order (including concurrently), in any combination or sub-combination.

Although features are described herein as being performed in a computing device, the features described herein may also be implemented, mutatis mutandis, on a desktop computer, a laptop computer, a netbook, a cellular phone, a personal digital assistant (PDA), or any other appropriate type of tablet computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

It will be readily understood to those skilled in the art that various other changes in the details, material, and arrangements of the parts and method stages which have been described and illustrated in order to explain the nature of this invention may be made without departing from the principles and scope of the invention as expressed.

Any single embodiment herein may be supplemented with one or more element from any one or more other embodiment herein.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A system for the exchange of crowd-funded start-up interests, the system comprising:
a processor;
a memory, the memory storing computer readable code that, when executed by the processor, causes the processor to:
display a first interface, the first interface comprising an input field configured to receive a crowd-funded start-up interest from a first investor;
receive the crowd-funded start-up interest from the first investor;
filter the crowd-funded start-up interest to assign a category to the crowd-funded start-up interest in order to create a filtered crowd-funded start-up interest; and
store the filtered crowd-funded start-up interest in an exchange database.

2. The system of claim 1, wherein the exchange database further includes at least one or more of an assigned first investor identification number; a crowd-funded start-up interest identification number; an interest principal value; an accrued value;
an ask price; a bid price; a markup; a discount; and a yield to maturity.

3. The system of claim 1, wherein the memory further causes the processor to display a second interface, the second interface comprising:
an access field configured to receive an access query from a second investor to allow the second investor to access the exchange database.

4. The system of claim 3, wherein the memory further causes the processor to receive an access query from a second investor; and allow the second investor to access a segment of the exchange database based on the access query.

5. The system of claim 4, wherein the second investor is a company; a partnership; or an individual.

6. The system of claim 4, wherein the second investor is a venture capital firm; an angel investor; a high net worth individual; a low net worth individual; an officer of the crowd-funded start-up; a representative of the crowd-funded start-up; a private equity firm; a hedge fund firm; or a speculator.

7. The system of claim 4, wherein the processor displays a third interface, the third interface comprising:
an information display including the segment of the exchange database; and
a selection field configured to receive a crowd-funded start-up interest selection from the second investor.

8. The system of claim 7, wherein the processor executes an exchange of the crowd-funded start-up interest in response to the crowd-funded start-up interest selection.

9. A computerized method for exchanging crowd-funded start-up interests, said method comprising:
receiving a crowd-funded start-up interest from a first investor;
filtering the crowd-funded start-up interest using a processor coupled to a non-transitory medium to assign a category to the crowd-funded start-up interest in order to create a filtered crowd-funded start-up interest; and
storing the filtered crowd-funded start-up interest in an exchange database.

10. The computerized method of claim 9, wherein the exchange database further includes at least one or more of an assigned first investor identification number; a crowd-funded start-up interest identification number; an interest principal value; an accrued value; an ask price; a bid price; a markup; a discount; and a yield to maturity. further comprising

[symbol]

11. The computerized method of claim 10 further comprising receiving an access query from a second investor to allow the second investor to access the exchange database.

12. The computerized method of claim 11, wherein the second investor is a company; a partnership; or an individual.

13. The computerized method of claim 11, wherein the second investor is a venture capital firm; an angel investor; a high net worth individual; a low net worth individual; an officer of the crowd-funded start-up; a representative of the crowd-funded start-up; a private equity firm; a hedge fund firm; or a speculator.

14. The computerized method of claim 11 further comprising receiving a crowd-funded start-up interest selection from the second investor; and executing an exchange of the crowd-funded start-up interest in response to the crowd-funded start-up interest selection.

15. A computerized method for assigning a crowd-funded start-up rating, the method comprising:
receiving a crowd-funded start-up characteristic related to a crowd-funded start-up;
receiving a rating criteria;
applying the rating criteria to the crowd-funded start-up characteristic using a processor coupled to a non-transitory medium to obtain a crowd-funded start-up rating;
calculating the crowd-funded start-up rating; and
assigning the crowd-funded start-up rating.

16. The method of claim 15, wherein the crowd-funded start-up characteristic includes at least one of intellectual property information, management information, funding information, maturity information, technology information, and market information.

17. The method of claim 15, wherein the crowd-funded start-up rating is a predictive metric of risk.
